(19) United States
(12) Patent Application Publication
(10) Pub. No.: US 2025/0370673 A1
(43) Pub. Date: Dec. 4, 2025

(54) PRINTING SYSTEM, PRINTING APPARATUS, CONTROL METHOD FOR PRINTING APPARATUS

(71) Applicant: CANON KABUSHIKI KAISHA, Tokyo (JP)

(72) Inventor: Tomoya Miyoshi, Kanagawa (JP)

(21) Appl. No.: 19/203,604

(22) Filed: May 9, 2025

(30) Foreign Application Priority Data
May 28, 2024 (JP) 2024-086461

(51) Int. Cl. G06F 3/12

(52) U.S. Cl. CPC G06F 3/1238; G06F 3/1205; G06F 3/1222

(57) ABSTRACT

The printing system includes a printing apparatus and a print server. The print server stores print jobs submitted by users along with their identification information, associating them with a comprehensive logical printer. The printing apparatus displays a two-dimensional code that encodes the identification information allocated to the logical printer. A mobile communication device reads this two-dimensional code and sends a print request to the print server. The print server receives the print request, which includes identification information for the logical printer and the user, and moves the associated print job to the logical printer. The printing apparatus then receives the print job from the logical printer.

### BACKGROUND OF THE INVENTION

### Field of the Technology

The present disclosure relates to a printing system, a printing apparatus, a control method for printing apparatus.

### Description of the Related Art

Cloud print services that use a cloud have been proposed. Each cloud print service provides a logical printer, and a print job submitted to the logical printer is executed by a physical printer associated with the logical printer. Printing that uses a logical printer may be called “cloud printing”. In a cloud print service, unique identification information is allocated to a logical printer. This identification information can also be called a “cloud print ID”. Japanese Patent Laid-Open No. 2016-81322 proposes presenting a two-dimensional code obtained by encoding a cloud print ID, in order to reduce the user operation to input the cloud print ID to a mobile terminal. In this technique, the two-dimensional code obtained by the encoding the cloud print ID is printed onto paper, and the paper is attached to a printing apparatus, thereby presenting the two-dimensional code. However, preparing such presentation is burdensome work for the user of the printing apparatus.

### SUMMARY OF THE INVENTION

Some aspects of the present disclosure provide a technique for reducing user operations.

One aspect of the present disclosure a printing system comprising a printing apparatus and a print server, the print server including: one or more first memory devices that store a set of instructions; and one or more first processors that execute the set of instructions to: manage a logical printer associated with the printing apparatus, and a comprehensive logical printer associated with the logical printer, store print jobs submitted to the comprehensive logical printer by a user along with identification information of the user in association with the comprehensive logical printer, receive a print request that includes identification information allocated to the logical printer and the identification information of the user, and move a print job related to the user's identification information included in the print request, from among the print jobs stored in association with the comprehensive logical printer, to a logical printer indicated by the identification information allocated to the logical printer and included in the print request, and the printing apparatus including: one or more second memory devices that store a set of instructions; and one or more second processors that execute the set of instructions to: receive the print job associated with the logical printer, from the print server, perform printing based on the print job, and electronically display a two-dimensional code obtained by the print server encoding the identification information allocated to the logical printer, on a display device of the printing apparatus, wherein the print request is transmitted from a mobile communication apparatus that has read the two-dimensional code, to the print server.

Another aspect of the present disclosure provides a printing apparatus comprising: a receiving unit configured to receive, from a print server that provides a logical printer associated with the printing apparatus, a print job associated with the logical printer; a print unit configured to perform printing based on the print job; a display control unit configured to electronically display, on a display device of the printing apparatus, a two-dimensional code obtained by encoding identification information allocated to the logical printer by the print server; and a setting unit configured to perform setting on whether or not to display the two-dimensional code obtained by encoding the identification information allocated to the logical printer.

Still another aspect of the present disclosure provides a method for controlling a printing apparatus, the method comprising: receiving, from a print server that provides a logical printer associated with the printing apparatus, a print job associated with the logical printer; performing printing based on the print job; electronically displaying, on a display device of the printing apparatus, a two-dimensional code obtained by encoding identification information allocated to the logical printer by the print server; and performing setting on whether or not to display the two-dimensional code.

Features of the present disclosure will become apparent from the following description of embodiments with reference to the attached drawings. The following description of embodiments are described by way of example.

### BRIEF DESCRIPTION OF THE DRAWINGS

FIG. 1 is a schematic diagram describing an exemplary configuration of a print system according to a first embodiment.

FIG. 2 is a block diagram describing an exemplary hardware configuration of a computer according to the first embodiment.

FIG. 3 is a block diagram describing an exemplary functional configuration of a print server according to the first embodiment.

FIG. 4 is a block diagram describing an exemplary functional configuration of an information processing apparatus according to the first embodiment.

FIG. 5 is a block diagram describing an exemplary hardware configuration of a printing apparatus according to the first embodiment.

FIG. 6 is a schematic diagram describing an exemplary configuration of an operation unit of the printing apparatus according to the first embodiment.

FIG. 7 is a block diagram describing an exemplary functional configuration of the printing apparatus according to the first embodiment.

FIG. 8 is a sequence diagram describing overall processing of cloud printing according to the first embodiment.

FIG. 9 is a schematic diagram describing a comprehensive logical printer and individual logical printers according to the first embodiment.

FIGS. 10A and 10B are diagrams respectively describing examples of printer information and job information according to the first embodiment.

FIG. 11 is a flowchart describing an exemplary operation of registering a printing apparatus according to the first embodiment.

FIG. 12 is a flowchart describing an exemplary operation of transmitting an instruction to move a print job according to the first embodiment.

FIG. 13 is a schematic diagram describing a comprehensive logical printer and individual logical printers according to the second embodiment.

FIG. 14 is a schematic diagram describing a comprehensive logical printer and individual logical printers according to the third embodiment.

FIG. 15 is a flowchart for describing an exemplary operation of moving print jobs according to the third embodiment.

FIG. 16 is a flowchart for describing an exemplary operation of moving print jobs according to the fourth embodiment.

FIG. 17 is a schematic diagram for describing an example of a setting screen according to a fifth embodiment.

FIG. 18 is a flowchart for describing setting for a two-dimensional code and hold printing according to the fifth embodiment.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### First Embodiment

### Exemplary Configuration of Print System

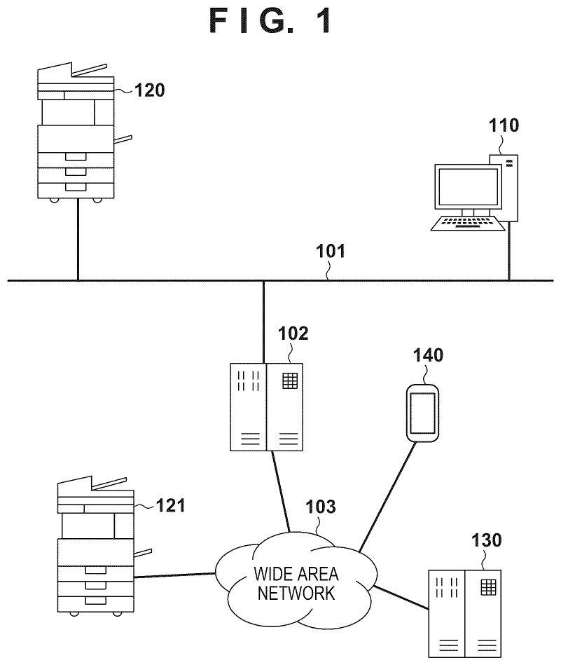

An exemplary configuration of a print system according to a first embodiment will be described with reference to FIG. 1. The print system includes an information processing apparatus 110, printing apparatuses 120 and 121, a print server 130, and a mobile communication apparatus 140, for example. The number of constituent elements of the print system is not limited to the example in FIG. 1. In addition, the print system may include a constituent element that is not shown in FIG. 1.

The information processing apparatus 110 and the printing apparatus 120 are connected to the same local area network (LAN) 101. The LAN 101 may be a wired LAN or a wireless LAN, or may be a combination thereof. The LAN 101 is connected to a wide area network 103 (for example, the Internet) via a firewall 102. The printing apparatus 121 and the print server 130 are also connected to the wide area network 103. The information processing apparatus 110 and the printing apparatus 120 can communicate with each other within the LAN 101 (that is to say, without using the wide area network 103). In addition, the information processing apparatus 110 and the printing apparatus 120 can communicate with the print server 130 through the LAN 101, the firewall 102, and the wide area network 103. The printing apparatus 121 may be connected to the wide area network 103 through a LAN or a cellular network (for example, a network that complies with the fourth-generation communication standard (4G) or the fifth-generation communication standard (5G)). The information processing apparatus 110 and the mobile communication apparatus 140 may also be connected to the wide area network 103 through a cellular network. In addition, the mobile communication apparatus 140 may also be connectable to the LAN 101.

The printing apparatuses 120 and 121 have a print function of performing printing based on a print job. The printing apparatuses 120 and 121 may have at least one of a scanner function or a facsimile function in addition to the print function. A printing apparatus that has a plurality of functions in this manner may also be referred to as a multifunction printer (MFP). Alternatively, the printing apparatuses 120 and 121 may be dedicated machines (SFPs: Single Function Peripherals) that have the print function only. Printing may be printing that is performed onto a sheet-like recording medium such as paper, or may be formation of a three-dimensional object (so-called three-dimensional printing).

The print server 130 provides a print service for transmitting a print job to any printing apparatus (for example, the printing apparatus 120), in accordance with a print job generated by the information processing apparatus 110. The print server 130 provides a logical printer to the information processing apparatus 110, and accepts a print job for the logical printer, for example. The logical printer is a virtual printing apparatus (for example, a printer object) provided by the print server 130. The logical printer can also be referred to as a “cloud printer”. The information processing apparatus 110 can also generate a print queue for the logical printer in a similar manner to the printing apparatuses 120 and 121. Compared with the logical printer, a physical printing apparatus such as the printing apparatus 120 or 121 can also be referred to as a “physical printer”. The physical printer can also be referred to as a “local printer” when connected to the same LAN connected to an information processing apparatus that submits a print job. In the following description, the logical printer and the physical printers are simply referred to as “printers” in a collective manner.

The print server 130 may be a server in an on-premise environment connected to the wide area network 103, or may be a server in a cloud computing environment (hereinafter, simply referred to as a “cloud”). A print service that is provided by the print server 130 in the cloud may also be referred to as a cloud print service (hereinafter, referred to as a “CPS”). Universal Print (registered trademark) provided by Microsoft (registered trademark) corporation is an example of the cloud print service. In the following description, a case will be described in which the print server 130 is in a cloud. However, the following description also applies to a case where the print server 130 is in an on-premise environment.

The information processing apparatus 110 provides a print function to the user of the information processing apparatus 110. The information processing apparatus 110 may designate a physical printer (for example, the printing apparatus 120) connected to the sane LAN 101, as an output destination, or may designate a logical printer provided by the print server 130, as an output destination. When the logical printer is designated as an output destination, a physical printer (for example, the printing apparatus 120) associated with the logical printer performs printing. The information processing apparatus 110 that uses CPS may also be referred to as a “client” or a “client terminal”. Printing that is performed by submitting a print job to the logical printer can also be referred to as “cloud printing”. Printing that is performed through cloud printing may be executed by the printing apparatus 120 connected to the same LAN 101 to which the information processing apparatus 110 is connected, or may also be executed by the printing apparatus 121 that is not connected to the LAN 101. Printing that is performed by directly (that is to say, within the LAN) submitting a print job to a physical printer can be referred to as “local print”.

### Exemplary Hardware Configuration of Computer

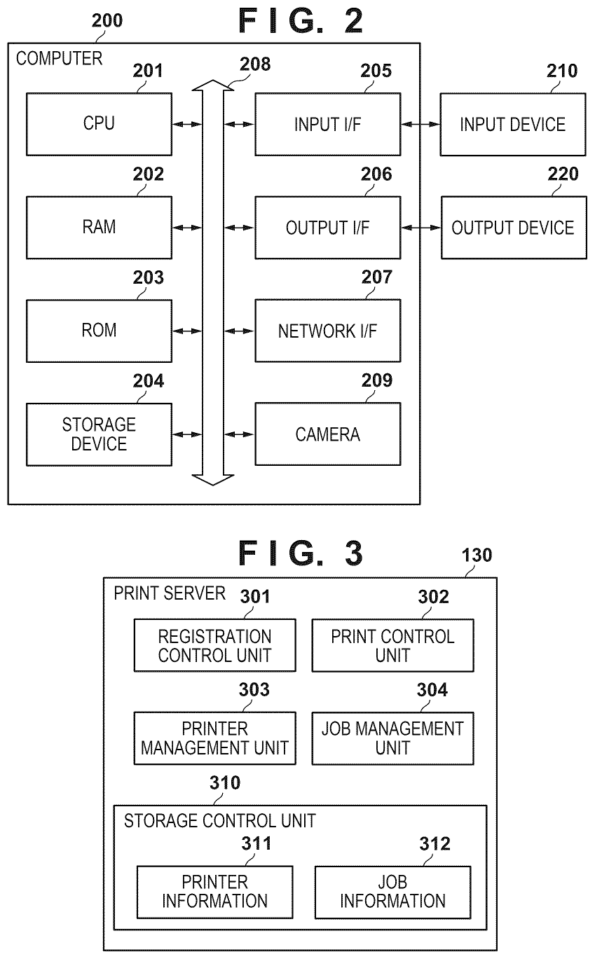

An exemplary hardware configuration of the computer 200 according to the present embodiment will be described with reference to FIG. 2. The computer 200 may be used as the information processing apparatus 110, may be used as the print server 130, or may be used as the mobile communication apparatus 140. The computer 200 may include the constituent elements shown in FIG. 2.

A central processing unit (CPU) 201 is a general-purpose processing circuit for controlling overall operations of the computer 200. A random access memory (RAM) 202 is a volatile memory circuit, and is used as a temporary storage region such as a work area for processing that is performed by the CPU 201. A read-only memory (ROM) 203 is a non-volatile memory circuit, and stores programs and data that are used for processing that is performed by the CPU 201. A storage device 204 is a non-volatile storage device, and stores programs and data that are used for processing that is performed by the CPU 201. The storage device 204 may be a hard disk drive (HDD) or a solid state drive (SSD), for example. The storage device 204 may also be referred to as a “secondary storage unit”. Operations that are performed by the computer 200 may be realized by the CPU 201 executing programs loaded from the storage device 204 to the RAM 202.

An input interface (I/F) 205 is an I/F for transmitting/receiving signals to/from an input device 210. The input device 210 is a device for obtaining input from the user of the computer 200. The input device 210 may be a keyboard, a touch panel, a microphone, a mouse, or any combination thereof, for example. An output I/F 206 is an I/F for transmitting/receiving signals to/from an output device 220. The output device 220 is a device for providing information to the user of the computer 200. The output device 220 may be a display, a speaker, or any combination thereof, for example. A network I/F 207 is an I/F for communicating with an external apparatus of the computer 200. The CPU 201, the RAM 202, the ROM 203, the storage device 204, the input I/F 205, the output I/F 206, and the network I/F 207 are connected to a system bus 208. In the example in FIG. 2, the input device 210 and the output device 220 are illustrated as devices different from the computer 200. Alternatively, the computer 200 may include the input device 210 and the output device 220. When, for example, the computer 200 is used as the mobile communication apparatus 140, the mobile communication apparatus 140 may include the input device 210 and the output device 220. Furthermore, the computer 200 (specifically, the mobile communication apparatus 140) may include a camera 209.

### Exemplary Functional Configuration of Print Server

An exemplary functional configuration of the print server 130 will be described with reference to FIG. 3. The print server 130 may include the functional units shown in FIG. 3. The print server 130 may include a functional unit that is not shown in FIG. 3. The functional units in FIG. 3 may be realized by the CPU 201 executing programs loaded to the RAM 202. Alternatively, some or all of the functional units in FIG. 3 may be realized by a dedicated processing circuit such as an application specific integrated circuit (ASIC).

A registration control unit 301 performs processing for registering a logical printer. The registration control unit 301 generates a logical printer associated with a physical printer in accordance with a registration start request from a printing apparatus, and registers the generated logical printer in printer information 311, for example. The logical printer registered in the printer information 311 is recognized as a printer by the information processing apparatus 110. The physical printer associated with the logical printer may be a physical printer that performs printing in accordance with a print job submitted to the logical printer. The logical printer may be associated with only one physical printer. The physical printer may be associated with only one logical printer, or may be associated with a plurality of logical printers.

A print control unit 302 performs processing related to a print job for the logical printer. The print control unit 302 receives a print job for the logical printer, from the information processing apparatus 110, and based on this, transmits the print job to the physical printer associated with the logical printer, for example. In addition, the print control unit 302 may control an event related to the print job. An event related to a print job may include receiving a print job, for example. In response to an event request received from the physical printer, the print control unit 302 may return an event related to the physical printer.

A printer management unit 303 manages information related to the logical printer registered in the print server 130, as the printer information 311. The printer information 311 includes capability information of the physical printer associated with the logical printer, a cloud printer ID uniquely allocated to the logical printer, information regarding a print queue in which a print job is spooled, and the like. The cloud printer ID may be the UUID of the physical printer.

A job management unit 304 manages information regarding a print job received from the information processing apparatus 110, as job information 312. The job information 312 includes information regarding a print job and the state of the print job, print data included in the print job, and the like. A storage control unit 310 stores information to the RAM 202 or the storage device 204, and reads out information from the RAM 202 or the storage device 204, in accordance with an instruction from another functional unit. According to the present embodiment, the storage control unit 310 stores the printer information 311 and the job information 312.

### Exemplary Functional Configuration of Information Processing Apparatus

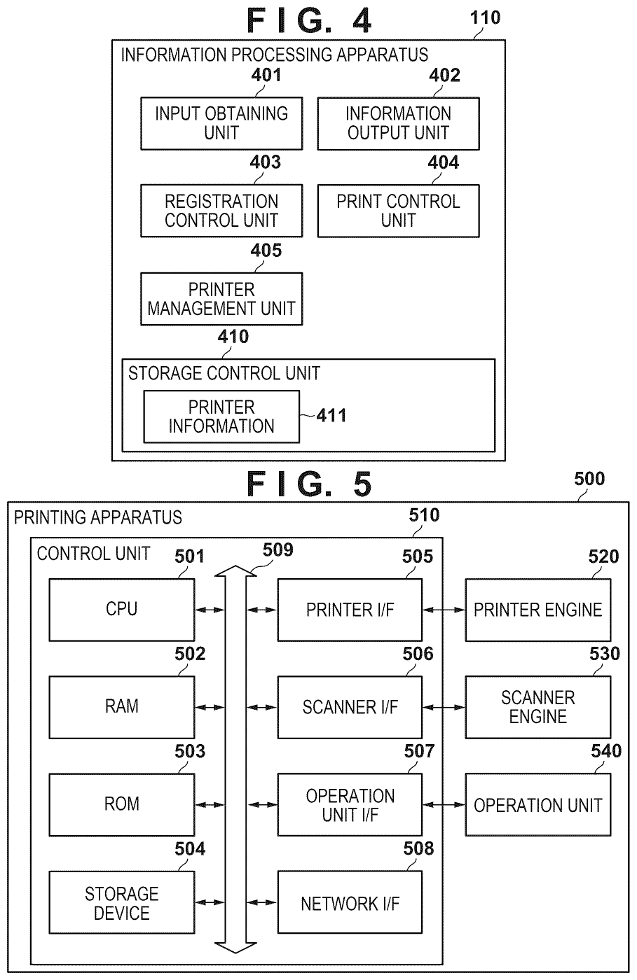

An exemplary functional configuration of the information processing apparatus 110 will be described with reference to FIG. 4. The information processing apparatus 110 may include the functional units shown in FIG. 4. The information processing apparatus 110 may include a functional unit that is not shown in FIG. 4. The functional units in FIG. 4 may be realized by the CPU 201 executing programs loaded to the RAM 202. Alternatively, some or all of the functional units in FIG. 4 may be realized by a dedicated processing circuit such as an ASIC.

An input obtaining unit 401 obtains input from the user of the information processing apparatus 110 using the input I/F 205. An information output unit 402 outputs information to the user of the information processing apparatus 110 using the output I/F 206.

A registration control unit 403 performs processing for registering a logical printer to the print server 130. A print control unit 404 performs processing related to printing that is performed by a printer. The print control unit 404 may transmit a print job to the logical printer registered in the print server 130, in accordance with a print instruction from the user of the information processing apparatus 110, for example. The print control unit 404 may transmit a print job directly (that is to say, in the same LAN) to a physical printer in accordance with a print instruction from the user of the information processing apparatus 110.

A printer management unit 405 manages information regarding a printer to which the information processing apparatus 110 can submit a print job, as printer information 411. The printer information 411 includes capability information of the printer and the like.

A storage control unit 410 stores information to the RAM 202 or the storage device 204 and reads out information from the RAM 202 or the storage device 204 in accordance with an instruction from another functional unit. According to the present embodiment, the storage control unit 410 stores the printer information 411.

### Exemplary Hardware Configuration of Printing Apparatus

An exemplary hardware configuration of a printing apparatus 500 according to the present embodiment will be described with reference to FIG. 5. The printing apparatus 500 may be used as the printing apparatus 120, or may be used as the printing apparatus 121. The printing apparatus 500 may include the constituent elements shown in FIG. 5. The printing apparatus 500 is a physical printing apparatus, and thus is also referred to as a “physical printer”.

A CPU 501 is a general-purpose processing circuit for controlling overall operations of the printing apparatus 500. A RAM 502 is a volatile memory circuit, and is used as a temporary storage region such as a work area for processing that is performed by the CPU 501. A ROM 503 is a non-volatile memory circuit, and stores programs and data used for processing that is performed by the CPU 501. A storage device 504 is a non-volatile storage unit, and stores programs and data that are used for processing that is performed by the CPU 501 (for example, a print job, image data, and setting information). The storage device 504 may be an HDD or an SSD, for example. The storage device 504 may also be referred to as a “secondary storage unit”. Operations that are performed by the printing apparatus 500 may be realized by the CPU 501 executing programs loaded from the storage device 504 to the RAM 502.

A printer I/F 505 is an I/F for transmitting/receiving signals to/from a printer engine 520. The printer engine 520 performs printing based on a signal (for example, image signals or a print command) supplied from a control unit 510 through the printer I/F 505. Printing may be electrophotographic printing in which toner is transferred onto paper and is fixed, may be inkjet printing that is performed by discharging ink to paper, or may be three-dimensional printing.

A scanner I/F 506 is an I/F for transmitting/receiving signals to/from a scanner engine 530. The scanner engine 530 supplies signals (for example, image signals) obtained by reading a document, to the control unit 510 via the scanner I/F 506. The CPU 501 may process the image signals supplied from the scanner engine 530, and supply record image signals obtained as a result of the processing, to the printer engine 520. In addition, the CPU 501 may generate image data based on the image signals supplied from the scanner engine 530, and transmit the generated image data to an external apparatus.

An operation unit I/F 507 is an I/F for transmitting/receiving signals to/from an operation unit 540. The operation unit 540 is a device that obtains input from the user of the printing apparatus 500, and provides information to the user of the printing apparatus 500. The operation unit 540 may be a display panel (for example, a liquid crystal display), a speaker, a touch panel, a keyboard, buttons, or a touch screen, or may be constituted by any combination thereof, for example.

A network I/F 508 is an I/F for communicating with an external apparatus of the printing apparatus 500. The control unit 510 is constituted by the CPU 501, the RAM 502, the ROM 503, the storage device 504, the printer I/F 505, the scanner I/F 506, the operation unit I/F 507, and the network I/F 508. The constituent elements included in the control unit 510 are connected to a system bus 509.

### Exemplary Configuration of Operation Unit of Printing Apparatus

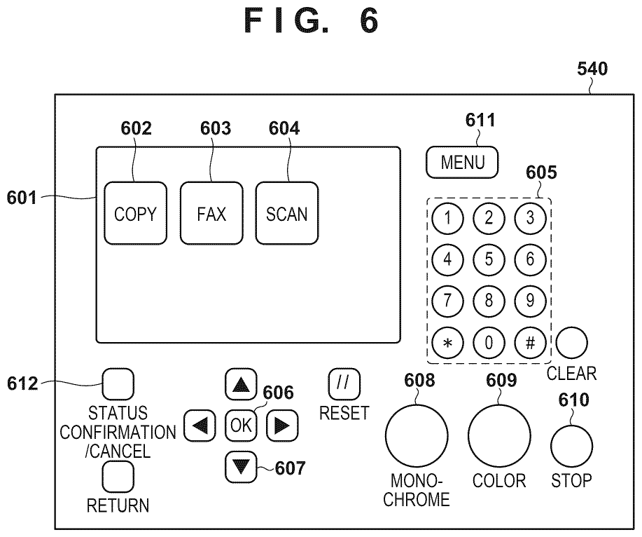

An exemplary configuration of the operation unit 540 of the printing apparatus 500 will be described with reference to FIG. 6. In the example in FIG. 6, the operation unit 540 is configured as an operation panel made in the form of a panel. The operation unit 540 may include the constituent elements shown in FIG. 6. The operation unit 540 may also include a constituent element that is not shown in FIG. 6.

A display panel 601 is a touch screen obtained by integrally forming a touch panel for obtaining input from the user and a display (for example, a liquid crystal display) for displaying information to the user. In the example in FIG. 6, buttons 602 to 604 are displayed on the display panel 601. The button 602 is a software button for obtaining, from the user, an instruction to make a switch to a copy mode. The printing apparatus 500 displays a copy operation screen on the display panel 601 in accordance with the user touching the button 602. The button 603 is a software button for obtaining, from the user, an instruction to make a switch to a facsimile mode. The printing apparatus 500 displays a facsimile operation screen on the display panel 601 in accordance with the user touching the button 603. The button 604 is a software button for obtaining, from the user, an instruction to make a switch to a scanner mode. The printing apparatus 500 displays a scanner operation screen on the display panel 601 in accordance with the user touching the button 604. In addition, a dialogue for interaction with the user, and a job list of cloud printing may be displayed on the display panel 601. A numeric keypad 605 is a group of physical buttons for obtaining, from the user, input of a number or the like. A button 606 is a physical button for obtaining, from the user, an instruction to determine display content on the display panel 601, or the like. Direction keys 607 are physical buttons for obtaining, from the user, an instruction to select an item from a menu displayed on the display panel 601, or the like. A button 608 is a physical button for obtaining an instruction for monochrome copy, from the user. A button 609 is a physical button for obtaining an instruction for color copy, from the user. A button 610 is a physical button for obtaining, from the user, an instruction to stop processing. A button 611 is a physical button for obtaining, from the user, an instruction to display a menu screen for performing settings of the printing apparatus 500 and the like. A button 612 is a physical button for obtaining, from the user, an instruction to display the state of the printing apparatus 500, such as a list of print jobs that the printing apparatus 500 has received.

### Exemplary Functional Configuration of Printing Apparatus

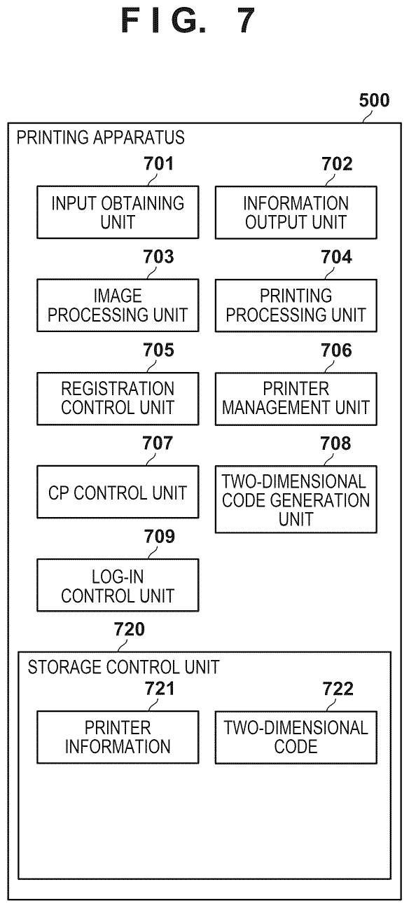

An exemplary functional configuration of the printing apparatus 500 will be described with reference to FIG. 7. The printing apparatus 500 may include the functional units shown in FIG. 7. The printing apparatus 500 may include a functional unit that is not shown in FIG. 7. The functional units in FIG. 7 may be realized by the CPU 501 executing programs loaded to the RAM 502. Alternatively, some or all of the functional units in FIG. 7 may also be realized by a dedicated processing circuit such as an ASIC.

An input obtaining unit 701 obtains input from the user of the printing apparatus 500 using the operation unit I/F 507. An information output unit 702 outputs information to the user of the printing apparatus 500 using the operation unit I/F 507. An image processing unit 703 renders a print job to produce printing image data. A printing processing unit 704 prints the image data obtained by the image processing unit 703 rendering the print job.

A registration control unit 705 performs processing for registering a logical printer associated with the printing apparatus 500 to the print server 130. A printer management unit 706 manages information regarding the printing apparatus 500 as printer information 721. The printer information 721 may include, for example, the state of the printing apparatus 500, the capability of the printing apparatus 500, and a cloud printer ID uniquely allocated by the print server 130 to the logical printer associated with the printing apparatus 500. In addition, the printer information 721 may include local printer IDs for the information processing apparatus 110 to identify printing apparatuses within the same LAN 101.

A cloud print (CP) control unit 707 performs processing related to cloud printing. The CP control unit 707 may transfer print data received from the print server 130, to the image processing unit 703, for example. In addition, the CP control unit 707 may transmit an event request to the print server 130.

A two-dimensional code generation unit 708 generates a two-dimensional code by encoding information (for example, a cloud printer ID). The two-dimensional code may be a QR code (registered trademark) or another two-dimensional code. A log-in control unit 709 controls processing for logging into the printing apparatus 500, which is performed by the user of the printing apparatus 500.

A storage control unit 720 stores information to the RAM 502 or the storage device 504, and reads out information from the RAM 502 or the storage device 504, in accordance with an instruction from another functional unit. According to the present embodiment, the storage control unit 720 stores printer information 721 and a two-dimensional code 722. The two-dimensional code 722 is a two-dimensional code obtained by encoding a cloud printer ID allocated to the logical printer associated with the printing apparatus 500.

### Overall Processing Sequence of Cloud Printing

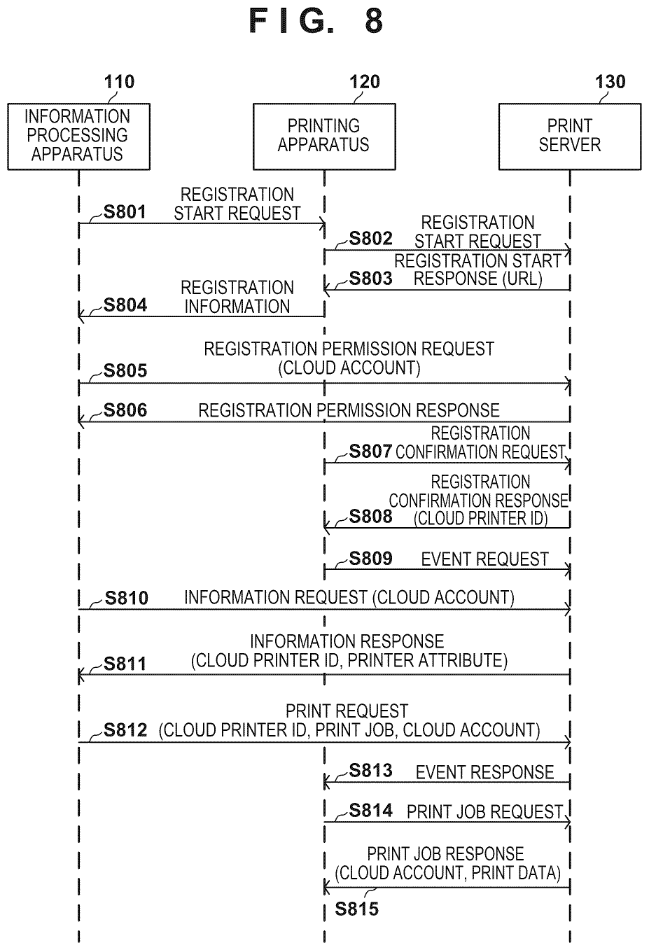

A sequence of overall processing for performing cloud printing will be described with reference to FIG. 8. The example in FIG. 8 illustrates a case where the information processing apparatus 110 registers the printing apparatus 120 to the print server 130, and submits a print job to a logical printer associated with the printing apparatus 120. Registering the printing apparatus 120 to the print server 130 may be registering the logical printer associated with the printing apparatus 120 to the print server 130. Assume that, in the following example, the printing apparatus 120 supports a Web User Interface (UI) function for operating the printing apparatus 120 through the information processing apparatus 110. In addition, assume that the information processing apparatus 110 supports a Web UI client function. Mutual communication between the information processing apparatus 110, the printing apparatus 120, and the print server 130 may be performed using an Internet Printing Protocol (IPP).

In step S801, the registration control unit 403 of the information processing apparatus 110 transmits a registration start request to the printing apparatus 120 in accordance with an instruction from the user of the information processing apparatus 110. The registration start request may be a request to start processing for registering the printing apparatus 120 to the print server 130. The registration start request may be transmitted using the Web UI client function of the information processing apparatus 110.

In step S802, the registration control unit 705 of the printing apparatus 120 transmits a registration start request to the print server 130 in accordance with the registration start request being received from the information processing apparatus 110. The registration start request may be a request to start processing for registering the printing apparatus 120 to the print server 130.

In step S803, the registration control unit 301 of the print server 130 transmits a registration start response to the printing apparatus 120 in accordance with the registration start request being received from the printing apparatus 120. The registration start response includes a uniform resource locator (URL) of a Web page for inputting information for the user of the information processing apparatus 110 to register the printing apparatus 120 to the print server 130.

In step S804, the registration control unit 705 of the printing apparatus 120 transmits registration information to the information processing apparatus 110 in accordance with the registration start response being received from the print server 130. The registration information includes the URL included in the registration start response. The information output unit 402 of the information processing apparatus 110 displays the Web page to the user in accordance with the registration information being received from the printing apparatus 120.

In step S805, the registration control unit 403 of the information processing apparatus 110 transmits a registration permission request to the print server 130 in accordance with the user of the information processing apparatus 110 accessing the URL and inputting information required for registration. The registration permission request includes a cloud account of the user of the information processing apparatus 110. The cloud account is an account for the user to use a tenant in the cloud that includes the print server 130.

In step S806, the registration control unit 301 of the print server 130 checks whether or not the cloud account included in the registration permission request belongs to a user that has authority to register the printing apparatus 120 to the print server 130. If the cloud account belongs to a user that has the authority, the registration control unit 301 of the print server 130 transmits a registration permission response to the information processing apparatus 110. The registration permission response may be a message for performing notification of a result of checking whether or not the user of the information processing apparatus 110 is a user that has the authorization to register the printing apparatus 120.

In step S807, the printer management unit 706 of the printing apparatus 120 transmits a registration confirmation request to the print server 130 in accordance with the registration start response being received from the print server 130. The registration confirmation request is a request related to registration of the printing apparatus 120 to the print server 130, and, specifically, the registration confirmation request may be a request to register the printing apparatus 120 to the print server 130.

In step S808, the printer management unit 303 of the print server 130 generates a new logical printer in accordance with the registration confirmation request being received from the printing apparatus 120, associates the logical printer with the printing apparatus 120, and adds the logical printer to the printer information 311. Accordingly, the printing apparatus 120 is registered to the print server 130, and the information processing apparatus 110 can perform cloud printing that uses the logical printer. In addition, the printer management unit 303 of the print server 130 allocates a unique cloud printer ID to the generated logical printer, associates this cloud printer ID with the logical printer, and adds the cloud printer ID to the printer information 311. The registration control unit 301 of the print server 130 then transmits a registration confirmation response to the printing apparatus 120. The registration confirmation response includes the cloud printer ID of the printing apparatus 120. In addition, the two-dimensional code generation unit 708 of the printing apparatus 120 creates the two-dimensional code 722 obtained by encoding the received cloud printer ID. The storage control unit 720 of the printing apparatus 120 stores the two-dimensional code 722.

In step S809, the CP control unit 707 of the printing apparatus 120 transmits an event request to the print server 130 in accordance with the registration confirmation response being received from the print server 130. The event request may be a request to notify the printing apparatus 120 that an event related to the printing apparatus 120 has occurred, when it occurred. The event request may be a request related to an event of a print job being submitted to the logical printer associated with the printing apparatus 120.

In step S810, the printer management unit 405 of the information processing apparatus 110 transmits an information request to the print server 130 in accordance with an instruction from the user of the information processing apparatus 110. The information request may be a request to obtain information regarding a logical printer that can be used by the user of the information processing apparatus 110. The information request includes a cloud account of the user of the information processing apparatus 110.

In step S811, the printer management unit 303 of the print server 130 transmits an information response to the information processing apparatus 110 in accordance with the information request being received from the information processing apparatus 110. The information response includes the cloud printer ID and a printer attribute of each of one or more logical printers that can be used by the user of the information processing apparatus 110. The printer management unit 405 of the information processing apparatus 110 updates the printer information 411 based on the information response.

In step S812, the printer management unit 405 of the information processing apparatus 110 transmits a print request to the print server 130 in accordance with an instruction from the user of the information processing apparatus 110. The print request includes a cloud printer ID, information regarding a print job, and the cloud account of the user of the information processing apparatus 110. The information regarding the print job includes print data and print setting. The print request may be a request requesting that the print data included in the print request be printed by a logical printer that has the cloud printer ID included in the print request.

In step S813, the print control unit 302 of the print server 130 transmits an event response to the printing apparatus 120 associated with the logical printer, in accordance with the print request being received from the information processing apparatus 110. The event response is a response to the event request received in step S809. The event response is a response for performing notification that an event of a type specified by the event request has occurred.

In step S814, the CP control unit 707 of the printing apparatus 120 transmits a print job request to the print server 130 in accordance with the event response being received from the print server 130. The print job request may be a request to obtain a print job that is to be executed by the printing apparatus 120.

In step S815, the print control unit 302 of the print server 130 transmits a print job response to the printing apparatus 120 in accordance with the print job request being received from the printing apparatus 120. The print job response includes the cloud account and the print job. The printing apparatus 120 then performs printing based on the print job in accordance with the print job response being received from the print server 130. The print job response received by the printing apparatus 120 from the print server 130 may be the Fetch-Job Response of IPP.

In the description given with reference to FIG. 8, registration of the printing apparatus 120 in steps S801 to S806 and cloud printing in steps S810 to S815 may be performed by the same user, or may be performed by different users.

### Comprehensive Logical Printer and Individual Logical Printers

A comprehensive logical printer and individual logical printers that are provided by the print server 130 will be described. In the present embodiment, the print server 130 may be able to provide a comprehensive logical printer and individual logical printers. As described above, a logical printer is a virtual printing apparatus (for example, a printer object) provided by the print server 130. An individual logical printer is a logical printer associated with a specific physical printer. A print job submitted to an individual logical printer can be printed by a physical printer associated with the individual logical printer. A comprehensive logical printer is a logical printer that is not directly associated with a specific physical printer, and is associated with one or more individual logical printers. Typically, a comprehensive logical printer is associated with a plurality of individual logical printers. A print job submitted to the comprehensive logical printer moves to one of the individual logical printers associated with the comprehensive logical printer in accordance with an instruction from the user. In other words, the print job submitted to the comprehensive logical printer is submitted to one of the individual logical printers. The print job can then be printed by a physical printer associated with this individual logical printer.

A configuration may be adopted in which, for example, the registration control unit 705 of the print server 130 can register the comprehensive logical printer and the individual logical printers to the print server 130, in accordance with an instruction from the user of the printing apparatus 500 or the administrator of the print system. As described above, for example, in step S808 in FIG. 8, the registration control unit 403 of the print server 130 registers a logical printer. This logical printer is associated with a specific physical printer, and is thus registered as an individual logical printer. In addition, when a comprehensive logical printer is already registered in a tenant in a cloud to which a user that registered a physical printer belongs, the registration control unit 403 of the print server 130 may associate the newly registered individual logical printer with the comprehensive logical printer.

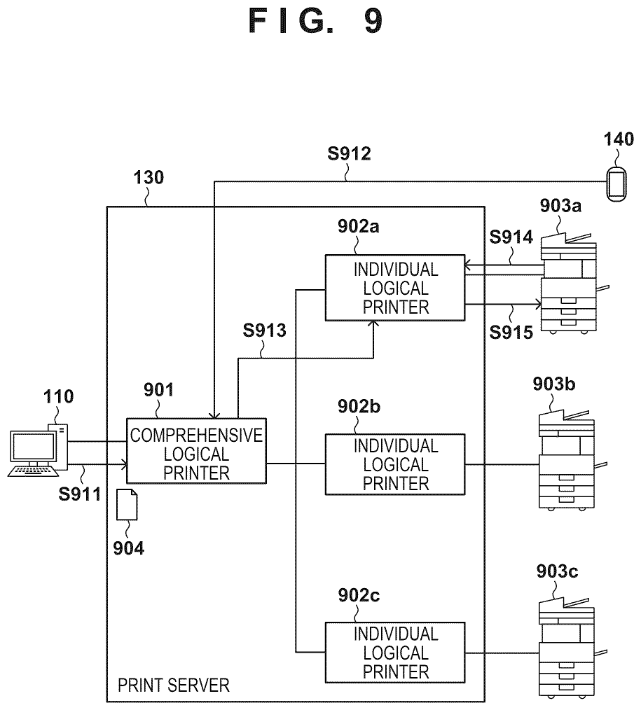

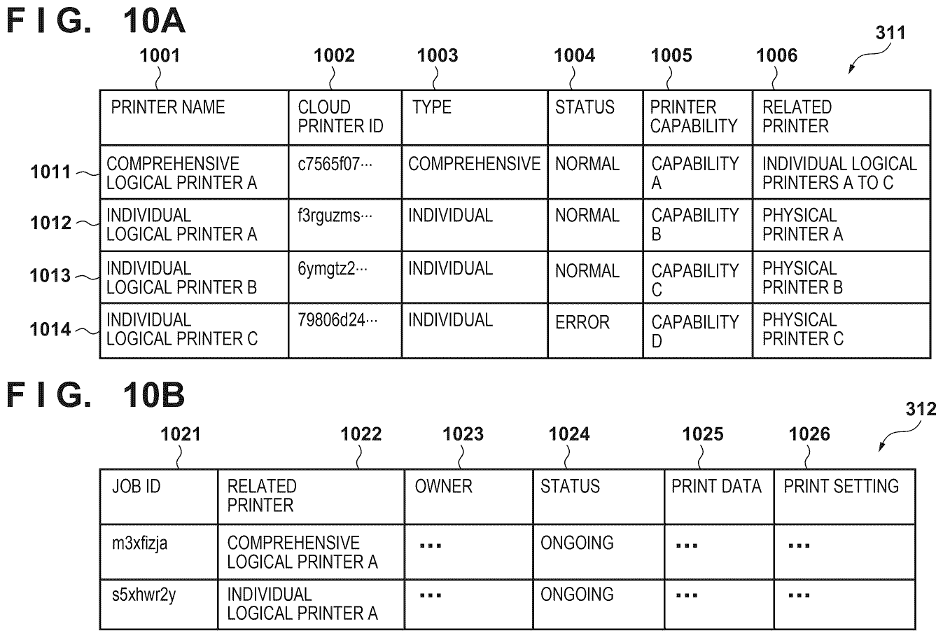

Examples of the comprehensive logical printer and the individual logical printers that are provided by the print server 130 will be described with reference to FIG. 9. One comprehensive logical printer 901 and three individual logical printers 902a to 902c are registered in the print server 130, and the print server 130 provides these four logical printers. The three individual logical printers 902a to 902c are all associated with the comprehensive logical printer 901. In addition, the three individual logical printers 902a to 902c are respectively associated with three physical printers 903a to 903c. The individual logical printer 902a is associated only with the physical printer 903a among the three physical printers 903a to 903c, for example. The physical printers 903a to 903c may have a configuration similar to that of the printing apparatus 500. The physical printers 903a to 903c may be connected to the same LAN 101 to which the information processing apparatus 110 is connected, as with the printing apparatus 120, and does not need to be connected to the same LAN 101 to which the information processing apparatus 110 is connected, as with the printing apparatus 121.

A processing flow of printing that is performed by submitting a print job to the comprehensive logical printer 901 will be described with reference to FIG. 9. In step S911, the print control unit 404 of the information processing apparatus 110 submits a print job 904 to the comprehensive logical printer 901. At this stage, the user of the information processing apparatus 110 does not need to specify which physical printer is to perform printing.

In step S912, in order to cause the physical printer 903a perform printing, the user that has submitted the print job 904 or another user instructs the print server 130 to move the print job 904 submitted to the comprehensive logical printer 901, to the individual logical printer 902a. This instruction may be given using either the mobile communication apparatus 140 or the physical printer 903a. This instruction includes identification information (job ID) of the job to be moved, and the cloud printer ID of the individual logical printer 902a that is a destination.

In step S913, the job management unit 304 of the print server 130 moves the print job 904 from the comprehensive logical printer 901 to the individual logical printer 902a. Accordingly, the print job 904 is associated with the individual logical printer 902a, and thus the print job 904 can be printed by the physical printer 903a.

In step S914, the CP control unit 707 of the physical printer 903a transmits a print job request to the individual logical printer 902a (step S814 in FIG. 8). In step S915, the print control unit 302 of the print server 130 transmits a print job response to the physical printer 903a in accordance with the print job request being received from the physical printer 903a (step S815 in FIG. 8). This print job response includes the print job 904. The printing processing unit 704 of the physical printer 903a then performs printing based on the print job 904.

In the above example, the user instructs that the print job 904 be moved from the comprehensive logical printer 901 to the individual logical printer 902a, but may instruct that the print job 904 be moved to the individual logical printer 902b or 902c. In this case, printing is performed by the physical printer 903b or 903c. In this manner, after the print job 904 is submitted to the print server 130, the user can cause any of the physical printers 903a to 903c to perform processing. Such a printing method can be called “pull printing”.

### Specific Example of Printer Information of Print Server and Specific Example of Job Information

A specific example of the printer information 311 that is managed by the printer management unit 303 of the print server 130 will be described with reference to FIG. 10A. In the example in this figure, the printer information 311 is stored in a table format. Records in the printer information 311 respectively represent logical printers. A logical printer may be a comprehensive logical printer, or may be an individual logical printer. A record 1011 represents the comprehensive logical printer 901 in FIG. 9, for example. Records 1012 to 1014 respectively represent the individual logical printers 902a to 902c in FIG. 9, for example. The printer information 311 may include information regarding a print queue, in addition to later-described information, for example.

A column 1001 shows the names of the logical printers. A column 1002 shows cloud printer IDs uniquely allocated to the logical printers by the print server 130. One individual logical printer is associated with one physical printer, and thus the cloud printer ID of the individual logical printer also uniquely identifies a physical printer. A column 1003 shows the types of the logical printers. A type of logical printer may be either “comprehensive” indicating that the type of the logical printer is a comprehensive logical printer or “individual” indicating that the type of the logical printer is an individual logical printer. A column 1004 shows the states of the logical printers.

A column 1005 shows the printer capabilities of the logical printers. If a logical printer is an individual logical printer, the printer capability of the individual logical printer may be a printer capability of a physical printer associated with the individual logical printer. The printer capability may be having a color print function, having a sort function, and the like. The printer capability of the comprehensive logical printer may be obtained through logical sum of the printer capabilities of one or more individual logical printers associated with the comprehensive logical printer. When, for example, at least one of the individual logical printers associated with the comprehensive logical printer has a sort function, or the other individual logical printers associated with the comprehensive logical printer do not have the sort function, the comprehensive logical printer may be managed as a logical printer that has the sort function.

A column 1006 shows printers associated with the logical printers. If a logical printer is a comprehensive logical printer, one or more individual logical printers are associated with this comprehensive logical printer. If a logical printer is an individual logical printer, one physical printer is associated with this individual logical printer.

A specific example of the job information 312 managed by the job management unit 304 of the print server 130 will be described with reference to FIG. 10B. In the example in this figure, the job information 312 is stored in a table format. Records in the job information 312 respectively represent print jobs submitted to the print server 130.

A column 1021 shows a job ID uniquely allocated to each print job by the print server 130. A column 1022 shows a logical printer associated with the print job. When a print job is submitted to a specific logical printer, this print job is associated with the specific logical printer. As described above with reference to FIG. 9, a logical printer associated with a print job may be changed to another logical printer in accordance with an instruction from the user.

A column 1023 shows a user that has submitted the print job. A column 1024 shows the state of the print job. A column 1025 shows print data to be printed based on the print job. A column 1026 shows settings for printing the print job.

Operation Flow of Registration Processing that is Performed by Printing Apparatus

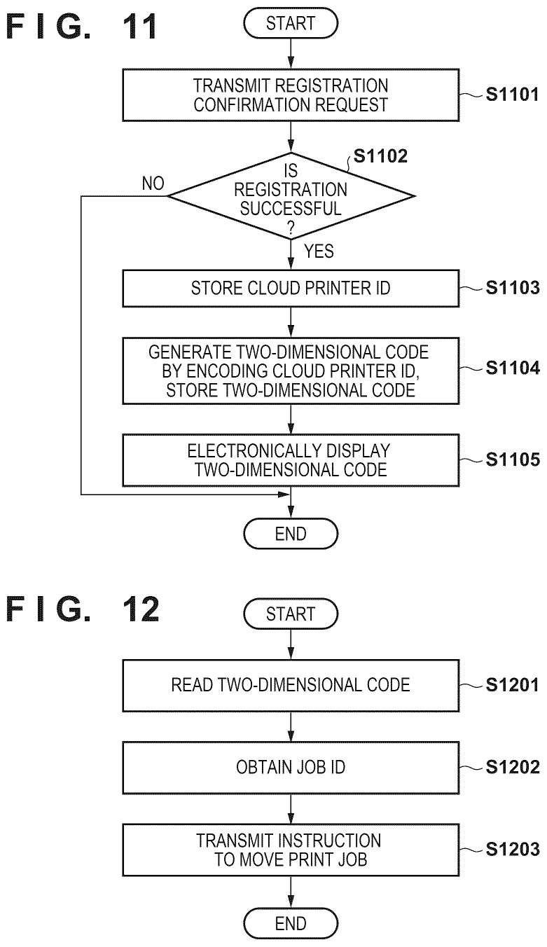

An exemplary operation for registering the printing apparatus 500 to the print server 130, which is performed by the printing apparatus 500, will be described in detail with reference to FIG. 11. The following operation corresponds to steps S807 to S808 in FIG. 8. In step S1101, the registration control unit 705 of the printing apparatus 500 transmits a registration confirmation request to the print server 130 (step S807 in FIG. 8).

In step S1102, the registration control unit 705 of the printing apparatus 500 determines whether or not the printing apparatus 500 has been successfully registered. If it is determined that the printing apparatus 500 has been successfully registered (YES in step S1002), the registration control unit 705 of the printing apparatus 500 advances the procedure to step S1103, and otherwise (NO in step S1002) ends the procedure. When ending the procedure, the information output unit 702 of the printing apparatus 500 may notify the user that registration has failed. The registration control unit 705 of the printing apparatus 500 may determine whether or not registration is performed successfully, based on the content of a registration confirmation response received from the print server 130.

In step S1103, the storage control unit 720 of the printing apparatus 500 stores a cloud printer ID included in the registration confirmation response. This cloud printer ID is identification information uniquely allocated to an individual logical printer associated with the printing apparatus 500. In step S1104, the two-dimensional code generation unit 708 of the printing apparatus 500 generates the two-dimensional code 722 by encoding the cloud printer ID included in the registration confirmation response. The storage control unit 720 of the printing apparatus 500 stores this two-dimensional code 722. In step S1105, the information output unit 702 of the printing apparatus 500 electronically displays the two-dimensional code 722 on the display panel 601.

Operation Flow of Print Job Move Instruction that is Given by Mobile Communication Apparatus

An exemplary operation in which the mobile communication apparatus 140 transmits an instruction to move a print job from the comprehensive logical printer to an individual logical printer will be described in detail with reference to FIG. 12. The following operation corresponds to step S912 in FIG. 9. An application for executing the following operation may be installed in the mobile communication apparatus 140 in advance. Assume that, before the operation in FIG. 11 is started, the operations in FIGS. 10A and 10B have been completed, and the two-dimensional code 722 is displayed on the display panel 601 of the printing apparatus 500.

In step S1201, the mobile communication apparatus 140 reads the two-dimensional code 722 in accordance with the user directing the camera 209 toward the two-dimensional code 722 displayed on the printing apparatus 500. The mobile communication apparatus 140 then obtains the cloud printer ID indicated by the two-dimensional code 722 by decoding the two-dimensional code 722.

In step S1202, the mobile communication apparatus 140 obtains the job ID of a print job submitted by the user. The job ID may be manually input by the user, or may be selected from a list of print jobs obtained from the print server 130.

In step S1203, the mobile communication apparatus 140 transmits, to the print server 130, an instruction to associate a print job that has the job ID obtained in step S1202, with an individual logical printer that has the cloud printer ID obtained in step S1202.

As described above, according to the present embodiment, the printing apparatus 500 electronically displays the two-dimensional code 722 indicating the cloud printer ID of the individual logical printer. Accordingly, the user operations to physically preparing a two-dimensional code is reduced.

### Second Embodiment

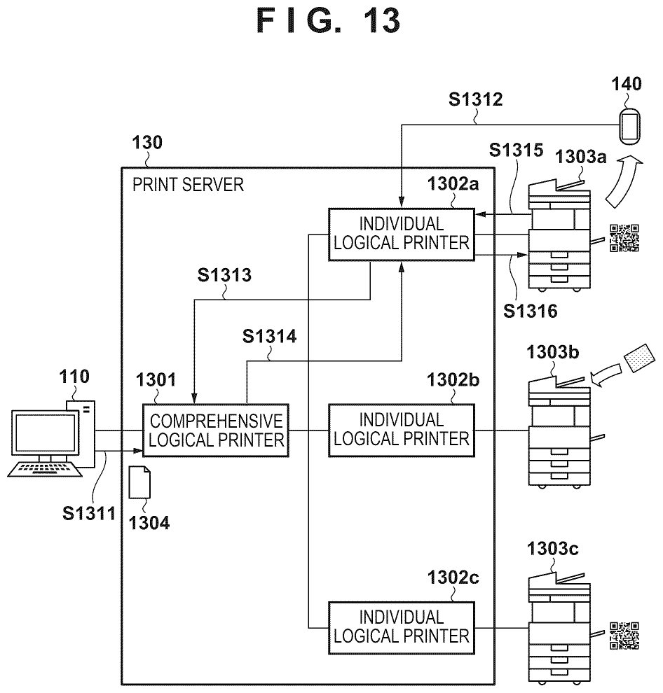

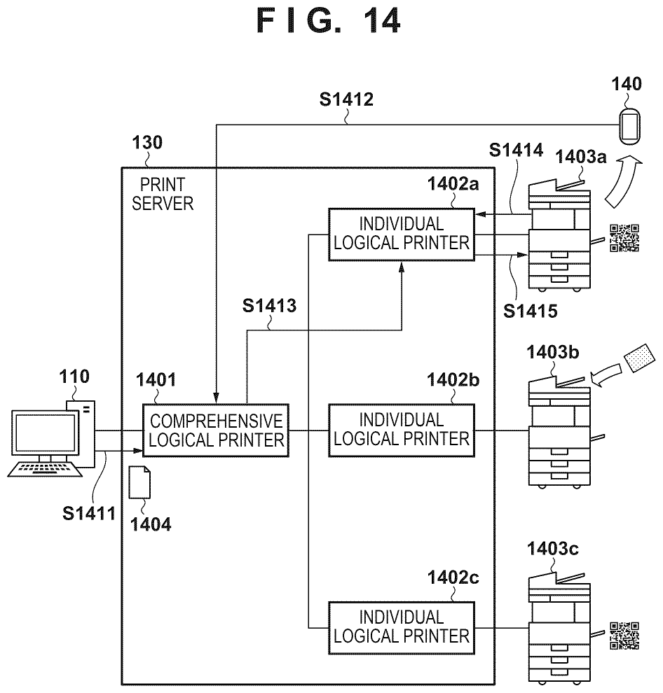

A printing apparatus 500 according to a second embodiment will be described with reference to FIGS. 13 and 14. Redundant description of content that may be similar to the first embodiment is omitted. The printing apparatus 500 according to the first embodiment can display the two-dimensional code 722 indicating a cloud printer ID, and print a print job submitted to the comprehensive logical printer 901. In the second embodiment, pull printing (hold printing) can be performed without specifying a print job.

Examples of individual logical printers provided by the print server 130 will be described with reference to FIG. 13. Three individual logical printers 1302a to 1302c are registered in the print server 130, and the print server 130 provides these three individual logical printers. In addition, the three individual logical printers 1302a to 1302c are respectively associated with three physical printers 1303a to 1303c. For example, the individual logical printer 1302a is associated with only the physical printer 1303a out of the three physical printers 1303a to 1303c. The physical printers 1303a to 1303c may each have a configuration similar to the configuration of the printing apparatus 500. The physical printers 1303a to 1303c may be connected to the same LAN 101 to which the information processing apparatus 110 is connected, as with the printing apparatus 120, and does not have to be connected to the same LAN 101 to which the information processing apparatus 110 is connected, as with the printing apparatus 121.

A processing flow of printing that is performed by submitting a print job to a comprehensive logical printer 1301 will be described with reference to FIG. 13. In step S1311, the print control unit 404 of the information processing apparatus 110 submits a print job 1304 to the comprehensive logical printer 1301. At this stage, the user of the information processing apparatus 110 does not need to specify which physical printer is to perform printing.

In step S1312, the user who submitted the print job 1304 makes a print request to cause the physical printer 1303a to perform printing. This print request may be given using the mobile communication apparatus 140 or the physical printer 1303a. This instruction includes the cloud printer ID of the individual logical printer 1302a to which print jobs are to be moved and user identification information for specifying the user. The user identification information may be any identification information by which the user is specified. The user identification information may be a user ID, for example. The difference from the first embodiment is that a print request is given to the individual logical printer 1302a using user identification information without specifying the print job 1304.

In a case where a print request is given using the mobile communication apparatus 140, the mobile communication apparatus 140 reads the two-dimensional code 722 displayed on the printing apparatus 500 in accordance with the user directing the camera 209 toward the two-dimensional code 722. The mobile communication apparatus 140 then obtains the cloud printer ID indicated by the two-dimensional code 722 by decoding the two-dimensional code 722. The mobile communication apparatus 140 then transmits the user identification information for specifying the mobile communication apparatus 140 and the obtained cloud printer ID to the print server 130.

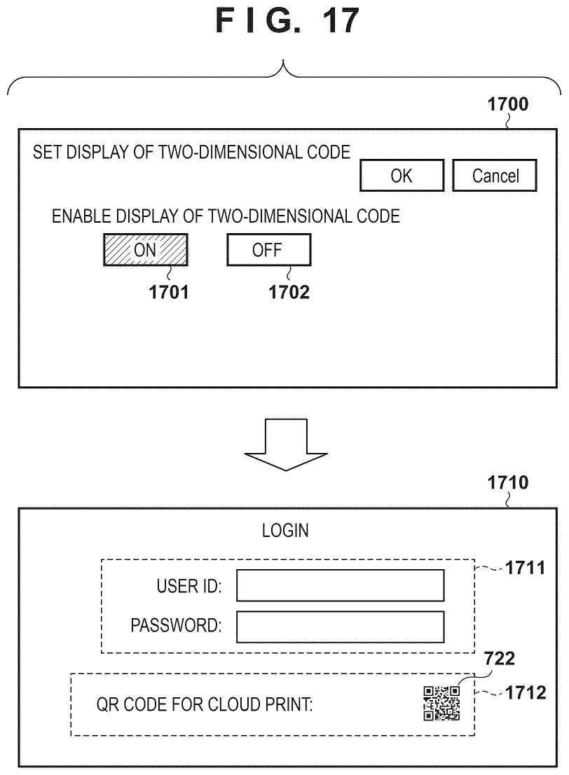

In a case where an instruction to execute a print job is given using the physical printer 1303a, an IC card or the mobile communication apparatus 140 is held over a card reading unit (not illustrated) of the physical printer 1303a. In addition, on a login screen to be described later with reference to FIG. 17, a user ID and a password may be input from the display panel 601. The user identification information can be obtained by being logged in or from the IC card or the mobile communication apparatus 140 that has been read by the card reading unit. In a case where the instruction is given from the physical printer 1303a, the obtained user identification information and the cloud printer ID of the individual logical printer 1302a for specifying itself are transmitted to the print server 130. FIG. 13 shows an example where user authentication is performed in the physical printer 1303a using an IC card.

The job management unit 304 of the print server 130 that received the print request in step S1312 instructs the actual printer 1303a corresponding to the cloud printer ID included in the print request to execute a print job. First, in step S1313, the actual printer 1303a gives a request to obtain a print job, to the comprehensive logical printer 1301. This obtaining request includes the user identification information and the cloud printer ID.

In step S1314, print jobs submitted by the user specified by the user identification information, from among print jobs submitted to and held in the comprehensive logical printer 1301, are moved from the comprehensive logical printer 1301 to the individual logical printer 1302a. At this time, the print jobs that are moved include the print job 1304, and also include other print jobs submitted by the user specified by the user identification information.

In step S1315, the CP control unit 707 of the physical printer 1303a transmits a print job request to the individual logical printer 1302a. In step S1316, the print control unit 302 of the print server 130 transmits a print job response to the physical printer 1303a in accordance with the print job request being received from the physical printer 1303a. This print job response includes the print jobs obtained in step S1314. The printing processing unit 704 of the physical printer 1303a then performs printing based on the print jobs.

In addition, the print job response transmitted to the physical printer 1303a in step S1316 may include a print job submitted to and held in the individual logical printer 1302a. In this case, the physical printer 1303a executes printing of the print job submitted to the individual logical printer 1302a along with the print jobs submitted to the comprehensive logical printer 1301. Note that step S1315 may be omitted. When the print jobs are obtained by the individual logical printer 1302a from the comprehensive logical printer 1301, printing may be executed without holding the print jobs.

In the above example, the user gives an instruction to move user's print jobs that include the print job 1304 from the comprehensive logical printer 1301 to the individual logical printer 1302a. The user may give an instruction to move the print jobs of the user specified by the user identification information from the comprehensive logical printer 1301 to the individual logical printer 1302b or 1302c. In this case, the physical printer 1303b or 1303c performs printing.

### Third Embodiment

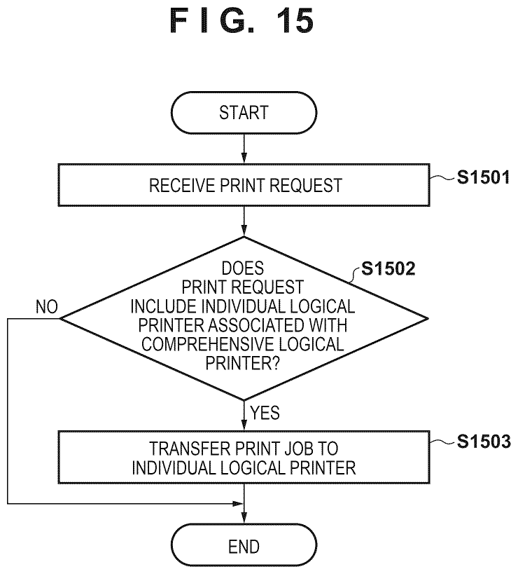

A printing apparatus 500 according to a third embodiment will be described with reference to FIGS. 14 and 15. Redundant description of content that may be similar to the first and second embodiments is omitted. The printing apparatus 500 according to the second embodiment obtains, from the individual logical printers 1302a to 1302c, print jobs held in the comprehensive logical printer 1301. In the third embodiment, a comprehensive logical printer transfers a print job to an individual logical printer associated with the comprehensive logical printer itself.

A processing flow of printing that is performed by submitting a print job to a comprehensive logical printer 1401 will be described with reference to FIG. 14. In step S1411, the print control unit 404 of the information processing apparatus 110 submits a print job 1404 to the comprehensive logical printer 1401. At this stage, the user of the information processing apparatus 110 does not need to specify which physical printer is to perform printing.

In step S1412, in order to cause a physical printer 1403a to perform printing, the user that has submitted the print job 1404 makes a print request. This print request may be given using the mobile communication apparatus 140 or the physical printer 1403a. This instruction includes the cloud printer ID of an individual logical printer 1402a to which a print job is to be moved, and user identification information for specifying the user.

When this instruction is given using the mobile communication apparatus 140, the mobile communication apparatus 140 reads the two-dimensional code 722 displayed on the printing apparatus 500 in accordance with the user directing the camera 209 toward the two-dimensional code 722. The mobile communication apparatus 140 then obtains the cloud printer ID indicated by the two-dimensional code 722 by decoding the two-dimensional code 722. The mobile communication apparatus 140 then transmits, to the print server 130, user identification information for specifying the mobile communication apparatus 140 and the obtained cloud printer ID.

In a case where an instruction to execute a print job is given using the physical printer 1403a, an IC card or the mobile communication apparatus 140 is held over a card reading unit (not illustrated) of the physical printer 1403a. In addition, on the login screen to be described later with reference to FIG. 17, a user ID and a password may be input from the display panel 601. The user identification information can be obtained by being logged in or from the IC card or the mobile communication apparatus 140 that has been read by the card reading unit. In a case where the instruction is given from the physical printer 1403a, the obtained user identification information and the cloud printer ID of the individual logical printer 1402a for specifying itself are transmitted to the print server 130. FIG. 14 shows an example where user authentication is performed in the physical printer 1403b using an IC card.

The job management unit 304 of the print server 130 that received the print request in step S1412 moves print jobs held in the comprehensive logical printer 1401 to the individual logical printer 1402a. An instruction to move a print job 1504 submitted to a comprehensive logical printer 1501, to an individual logical printer 1502a will be described with reference to FIG. 15.

In step S1501, the job management unit 304 of the print server 130 receives the print request of the individual logical printer 1402a. This print request includes the cloud printer ID of the individual logical printer 1402a and user identification information for specifying the user.

Next, in step S1502, the job management unit 304 of the print server 130 determines whether or not the individual logical printer 1402 that is specified by the cloud printer ID is subordinate to the comprehensive logical printer 1401. If the individual logical printer 1402 specified by the cloud ID is not subordinate to the comprehensive logical printer 1401 (if NO), the flow is ended. If the individual logical printer 1402 specified by the cloud ID is subordinate to the comprehensive logical printer 1401 (if YES), the procedure advances to step S1503.

In step S1503 (corresponding to step S1413 in FIG. 14), the job management unit 304 of the print server 130 moves all the print jobs held in the comprehensive logical printer 1401 and corresponding to the user identification information, to the individual logical printer 1402a specified by the cloud printer ID. Accordingly, all the print jobs submitted to the comprehensive logical printer 1401 by the user specified by the user identification information, including the print job 1404, are associated with the individual logical printer 1402a. For this reason, the print jobs submitted by the user specified by the user identification information can be printed by the physical printer 1403a.

Returning to FIG. 14, in step S1414, the CP control unit 707 of the physical printer 1403a transmits a print job request to the individual logical printer 1402a. In step S1415, the print control unit 302 of the print server 130 transmits a print job response to the physical printer 1403a in accordance with the print job request being received from the physical printer 1403a. This print job response includes the print jobs obtained in step S1414. The printing processing unit 704 of the physical printer 1403a then performs printing based on the print jobs.

In addition, the print job response that is transmitted to the physical printer 1403a in step S1415 may include a print job submitted to the individual logical printer 1402a by the user and held. In this case, the physical printer 1403a executes printing of the print job submitted to the individual logical printer 1402a, along with the print jobs submitted to the comprehensive logical printer 1401. Note that step S1414 may be omitted. When the print jobs are transferred from the comprehensive logical printer 1401 to the individual logical printer 1402a, the print jobs may be printed without being held.

In the above example, the user gives an instruction to move the user's print jobs that include the print job 1404 from the comprehensive logical printer 1401 to the individual logical printer 1402a. The user may give an instruction to move the print job of the user specified by the user identification information from the comprehensive logical printer 1401 to the individual logical printer 1402b or 1402c. In this case, a physical printer 1403b or 1403c performs printing.

### Fourth Embodiment

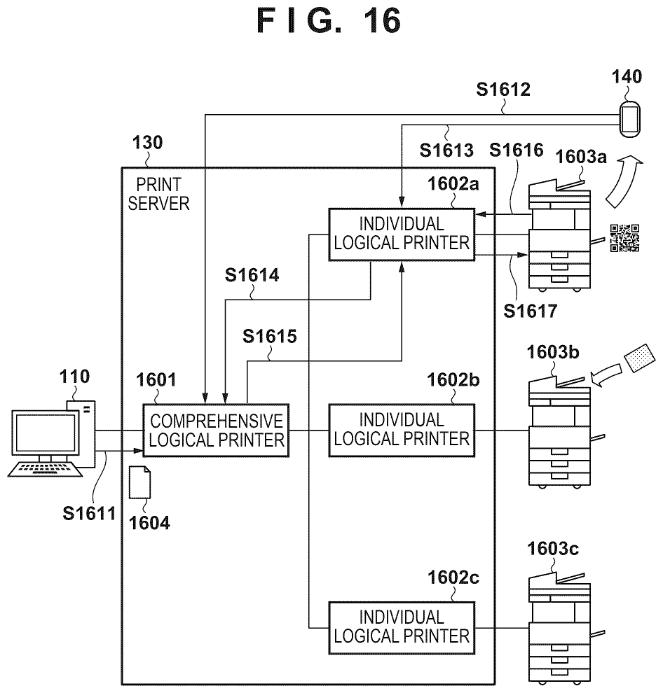

A printing apparatus 500 according to a fourth embodiment will be described with reference to FIG. 16. Redundant description of content that may be similar to the first to third embodiments is omitted. The printing apparatus 500 according to the fourth embodiment transmits a print request of physical printers 1603a to 1603c to both a comprehensive logical printer 1601 and individual logical printers 1602a to 1603c.

A processing flow of printing that is performed by submitting a print job to the comprehensive logical printer 1601 will be described with reference to FIG. 16. In step S1611, the print control unit 404 of the information processing apparatus 110 submits a print job 1604 to the comprehensive logical printer 1601. At this stage, the user of the information processing apparatus 110 does not need to specify which physical printer is to perform printing.

In steps S1612 and S1613, the user who submitted the print job 1404 makes a print request in order to cause the physical printer 1603a to perform printing. This print request may be given using the mobile communication apparatus 140 or the physical printer 1603a. This instruction includes the cloud printer ID of the individual logical printer 1602a to which print jobs are to be moved, and user identification information for specifying the user.

In a case where the instruction is given using the mobile communication apparatus 140, the mobile communication apparatus 140 reads the two-dimensional code 722 displayed on the printing apparatus 500 in accordance with the user directing the camera 209 toward the two-dimensional code 722. The mobile communication apparatus 140 then obtains the cloud printer ID indicated by the two-dimensional code 722 by decoding the two-dimensional code 722. The mobile communication apparatus 140 then transmits user identification information for specifying the mobile communication apparatus 140 and the obtained cloud printer ID to the print server 130.

In a case where an instruction to execute a print job is given using the physical printer 1403a, an IC card or the mobile communication apparatus 140 is held over a card reading unit (not illustrated) of the physical printer 1403a. In addition, on the login screen to be described later with reference to FIG. 17, a user ID and a password may be input from the display panel 601. User identification information can be obtained by being logged in or from the IC card or the mobile communication apparatus 140 that has been read by the card reading unit. In a case where the instruction is given from the physical printer 1603a, the obtained identification information and the cloud printer ID of the individual logical printer 1402a for specifying itself are transmitted to the print server 130. FIG. 14 shows an example where user authentication is performed in the individual printer 1602b using an IC card.

When a print request is given to the print server 130, the print server 130 can perform two types of processing. One of the two types of processing is similar to the second embodiment, and is performed based on step S1613. The other type of processing is similar to the third embodiment, and is performed based on step S1612.

The job management unit 304 of the print server 130 that received the print request in step S1613 instructs the actual printer 1603a corresponding to the cloud printer ID included in the print request to execute print jobs. First, in step S1614, the actual printer 1603a gives a request to obtain print jobs, to the comprehensive logical printer 1601. This obtaining request includes user identification information and the cloud printer ID.

In step S1615, print jobs submitted by the user from among print jobs submitted to and held in the comprehensive logical printer 1301 are moved from the comprehensive logical printer 1601 to the individual logical printer 1602a. At this time, the print jobs that are moved include the print job 1604, and also include other print jobs submitted by the user.

On the other hand, the job management unit 304 of the print server 130 that received the print request in step S1612 moves the print jobs held in the comprehensive logical printer 1601 in step S1614 to the individual logical printer 1602a. This processing is similar to the processing in FIG. 15, and thus a description thereof is omitted.

The subsequent processing is similar to the second and third embodiments.

### Fifth Embodiment

A printing apparatus 500 according to a fifth embodiment will be described. Redundant description of content that may be similar to the first to fourth embodiments is omitted. After generating the two-dimensional code 722, the printing apparatus 500 according to the first to fourth embodiments may always display the two-dimensional code 722 while the printing apparatus 500 is in operation. Instead, the printing apparatus 500 according to the third embodiment can switch between ON and OFF of display of the two-dimensional code 722. The ON/OFF setting of the two-dimensional code 722 is in conjunction with settings of the pull printing (hold printing) function. When display of the two-dimensional code 722 is switched ON, the setting of the pull print (hold printing) function is enabled, and a print job submitted by the user is not immediately printed. The print job submitted by the user is held, the user causes the mobile communication apparatus 140 to read the two-dimensional code 722 and gives a print instruction, whereby the printing apparatus 500 executes printing.

A setting screen for changing the display setting of a two-dimensional code that is generated by the information output unit 702 of the printing apparatus 500 will be described with reference to FIG. 17. The setting screen may be generated in accordance with an instruction to display this screen being obtained from the user. The generated setting screen is displayed on the display panel 601.

The information output unit 702 of the printing apparatus 500 first generates a setting screen 1500. A setting screen 1700 is a top screen that is first displayed at the time of display setting of the two-dimensional code.

The setting screen 1700 includes buttons 1701 and 1702. The button 1701 is a button for obtaining an instruction to enable display of the two-dimensional code from the user. The button 1702 is a button for obtaining an instruction to disable display of the two-dimensional code from the user. The current state of the setting for enabling/disabling display of the two-dimensional code is indicated by button inversion. In the example of the screen 1700, a state is illustrated where display of the two-dimensional code is enabled. In accordance with an operation being performed on the button 1701, the information output unit 702 of the printing apparatus 500 generates the two-dimensional code 722, and displays it on the display panel 601. When an operation is performed on the button 1702, display of the two-dimensional code is disabled, and the two-dimensional code is not displayed.

An example of a display control operation of a login screen that is performed by the information output unit 702 of the printing apparatus 500 will be described with reference to FIG. 17. A login screen 1710 may start to be displayed, for example, when the printing apparatus 500 is started or has recovered from a sleep state. The generated login screen 1710 is displayed on the display panel 601 by the information output unit 702 of the printing apparatus 500.

The login screen 1710 is an example of a screen where the two-dimensional code 722 is displayed from the setting screen 1700. The information output unit 702 of the printing apparatus 500 displays the login screen 1710 that includes a login information input field, information indicating the state of a logical printer, and the two-dimensional code 722 (specifically, QR code). The login screen 1710 includes a login information input field 1711 and a two-dimensional code display area 1712. In this example, the login information input field 1711 is a field for inputting an ID and a password of the user.

In a state where a comprehensive logical printer is set as illustrated in the first to fourth embodiments, a submitted print job is held in the comprehensive logical printer. A physical printer then executes printing by the mobile communication apparatus 140 reading a two-dimensional code displayed on the physical printer. However, if the display setting of the two-dimensional code is switched OFF, it is not possible to execute the held print job using the two-dimensional code. In addition, if the display setting of the two-dimensional code is switched ON, the print job is also held in a queue of individual logical printers corresponding to physical printers, and thus there is a need to perform an operation twice in order to cause a physical printer to execute printing.

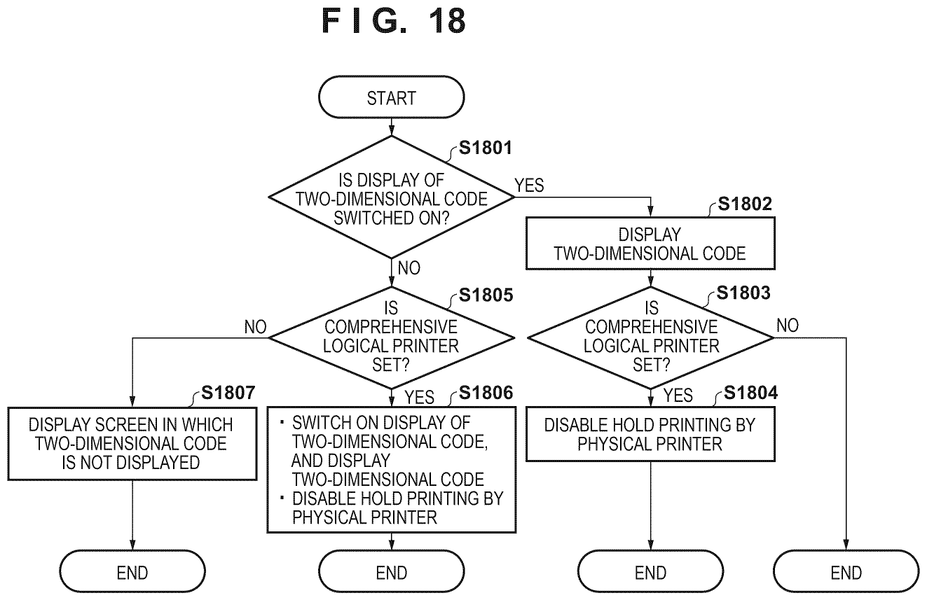

An example where the display setting of a two-dimensional code is switched ON and the setting for enabling/disabling hold printing is performed in accordance with the settings of a comprehensive logical printer will be described with reference to FIG. 18. In step S1801, determination is performed as to whether or not the display setting of the two-dimensional code is ON. If it is ON, the procedure advances to step S1802, and if it is OFF, the procedure advances to step S1805. If the display setting of the two-dimensional code is ON, the two-dimensional code is displayed in step S1802.

Next, the procedure advances to step S1803, where determination is performed as to whether or not a comprehensive logical printer is set in an individual logical printer corresponding to a physical printer. If it is not set (if NO), the flow is ended. On the other hand, if a comprehensive logical printer is set (if YES), the procedure advances to step S1804, and hold printing by the physical printer, namely the individual logical printer corresponding to the physical printer is disabled. By adopting such a configuration, if a comprehensive logical printer is not set, hold printing by the physical printer is enabled. On the other hand, if a comprehensive logical printer is set, a print job is held in the comprehensive logical printer, and thus holding a print job in the individual logical printer is disabled. For this reason, a print job moved from a queue in the comprehensive logical printer to the individual logical printer is immediately printed without being held.

Next, if it is determined in step S1801 that the display setting of the two-dimensional code is OFF (if NO in step S1801), the procedure advances to step S1805, where determination is performed as to whether or not a comprehensive logical printer is set in an individual logical printer corresponding to a physical printer. If a comprehensive logical printer is set (if YES), the procedure advances to step S1806, where the display setting of the two-dimensional code is switched ON, the two-dimensional code is displayed, and hold printing by the physical printer is disabled. The operation here is similar to the operation described in step S1804. Accordingly, even if display of the two-dimensional code is not set, the two-dimensional code is automatically displayed as long as a comprehensive logical printer is set.

In the flow in FIG. 18, the display setting of the two-dimensional code is automatically switched ON if a comprehensive logical printer is set. For example, the two-dimensional code may be displayed in step S1806 without switching ON the setting display of the two-dimensional code.

On the other hand, if it is determined in step S1805 that a comprehensive logical printer was not set, a screen on which the two-dimensional code is not displayed is displayed. For example, in FIG. 17, the login screen that includes only the login information input field 1711 is displayed. The flow is then ended.

According to the present embodiment, ON/OFF of display of the two-dimensional code 722 can be automatically set, and in accordance with the setting of the comprehensive logical printer, the setting for enabling/disabling hold printing by the physical printer is automatically performed. Accordingly, when the user sets a comprehensive logical printer, it is possible to automatically switch on display of the two-dimensional code 722, and disable hold printing by the physical printer. The user can execute printing of a print job by performing the operation once, using the two-dimensional code.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-086461, filed May 28, 2024 which is hereby incorporated by reference herein in its entirety.

What is claimed is:

1. A printing system comprising a printing apparatus and a print server,
the print server including:
one or more first memory devices that store a set of instructions; and
one or more first processors that execute the set of instructions to:
manage a logical printer associated with the printing apparatus, and a comprehensive logical printer associated with the logical printer,
store print jobs submitted to the comprehensive logical printer by a user along with identification information of the user in association with the comprehensive logical printer,
receive a print request that includes identification information allocated to the logical printer and the identification information of the user, and
move a print job related to the user's identification information included in the print request, from among the print jobs stored in association with the comprehensive logical printer, to a logical printer indicated by the identification information allocated to the logical printer and included in the print request, and
the printing apparatus including:
one or more second memory devices that store a set of instructions; and
one or more second processors that execute the set of instructions to:
receive the print job associated with the logical printer, from the print server,
perform printing based on the print job, and
electronically display a two-dimensional code obtained by the print server encoding the identification information allocated to the logical printer, on a display device of the printing apparatus,
wherein the print request is transmitted from a mobile communication apparatus that has read the two-dimensional code, to the print server.

2. The printing system according to claim 1,
wherein the moving is performed such that the logical printer indicated by the identification information allocated to the logical printer and included in the print request obtains the print job related to the identification information of the user included in the print request, from among the print jobs stored in association with the comprehensive logical printer, from the comprehensive logical printer related to the logical printer.

3. The printing system according to claim 1,
wherein the moving is performed such that the comprehensive logical printer associated with the logical printer indicated by the identification information allocated to the logical printer and included in the print request transfers the print job related to the identification information of the user included in the print request, from among the print jobs stored in association with the comprehensive logical printer, to the logical printer indicated by the identification information allocated to the logical printer and included in the print request.

4. The printing system according to claim 1,
wherein the printing apparatus performs setting on whether or not to display the two-dimensional code obtained by encoding the identification information allocated to the logical printer, and
the setting is setting for displaying the two-dimensional code if, in the print server, a logical printer associated with the printing apparatus is associated with the comprehensive logical printer.

5. The printing system according to claim 1,
wherein the printing apparatus performs setting on whether or not to display the two-dimensional code obtained by encoding the identification information allocated to the logical printer, and
the display control is to display the two-dimensional code if, in the print server, the logical printer associated with the printing apparatus is associated with the comprehensive logical printer, irrespective of the setting.

6. The printing system according to claim 1,
wherein, when, in the print server, the print job related to the user's identification information included in the print request is moved to the logical printer indicated by the identification information allocated to the logical printer and included in the print request, the printing apparatus immediately prints the print job.

7. A printing apparatus comprising:
a receiving unit configured to receive, from a print server that provides a logical printer associated with the printing apparatus, a print job associated with the logical printer;
a print unit configured to perform printing based on the print job;
a display control unit configured to electronically display, on a display device of the printing apparatus, a two-dimensional code obtained by encoding identification information allocated to the logical printer by the print server; and
a setting unit configured to perform setting on whether or not to display the two-dimensional code obtained by encoding the identification information allocated to the logical printer.

8. The printing apparatus according to claim 7,
wherein, when the setting unit performs setting for displaying the two-dimensional code is performed, setting is performed such that a print job submitted to the logical printer associated with the printing apparatus is held in the print server.

9. The printing apparatus according to claim 7,
wherein, if, in the print server, the logical printer associated with the printing apparatus is associated with a comprehensive logical printer, the setting unit performs setting for displaying the two-dimensional code.

10. The printing apparatus according to claim 7,
wherein, if, in the print server, the logical printer associated with the printing apparatus is associated with a comprehensive logical printer, the display control unit displays the two-dimensional code irrespective of setting performed by the setting unit.

11. The printing apparatus according to claim 7,
wherein, when, in the print server, a print job related to user's identification information included in a print request is moved to a logical printer indicated by identification information allocated to the logical printer included in the print request, the print job is immediately printed.

12. A method for controlling a printing apparatus, the method comprising:
receiving, from a print server that provides a logical printer associated with the printing apparatus, a print job associated with the logical printer;
performing printing based on the print job;
electronically displaying, on a display device of the printing apparatus, a two-dimensional code obtained by encoding identification information allocated to the logical printer by the print server; and
performing setting on whether or not to display the two-dimensional code.

13. The method for controlling a printing apparatus, according to claim 12,
wherein, if setting for displaying the two-dimensional code is performed, setting is performed such that a print job submitted to the logical printer associated with the printing apparatus is held in the print server.

14. The method for controlling a printing apparatus, according to claim 12,
wherein, if, in the print server, the logical printer associated with the printing apparatus is associated with a comprehensive logical printer, setting for displaying the two-dimensional code is performed.

15. The method for controlling a printing apparatus according to claim 12,
wherein, if, in the print server, the logical printer associated with the printing apparatus is associated with a comprehensive logical printer, the two-dimensional code is displayed irrespective of setting on whether or not to display the two-dimensional code.

16. The method for controlling a printing apparatus, according to claim 12,
in the print server, a print job related to user's identification information included in a print request is moved to a logical printer indicated by identification information allocated to the logical printer included in the print request, the print job is immediately printed.
